(19) United States
(12) Patent Application Publication
(10) Pub. No.: US 2026/0120270 A1
(43) Pub. Date: Apr. 30, 2026

(54) VOLUMETRIC DIFFERENCE ANALYSIS

(71) Applicant: Lumafield, Inc., Cambridge, MA (US)

(72) Inventors: Andreas Linas Bastian, San Francisco, CA (US); Daniel Micah Pipe-Mazo, Redondo Beach, CA (US); Steven Thomas, Somerville, MA (US)

(21) Appl. No.: 19/368,302

(22) Filed: Oct. 24, 2025

Related U.S. Application Data
(60) Provisional application No. 63/712,207, filed on Oct. 25, 2024.

(51) Int. Cl. G06T 7/00; G06T 7/13; G06T 7/33; G06T 7/62; G06T 11/00

(52) U.S. Cl. CPC G06T 7/001; G06T 7/13; G06T 7/337; G06T 7/62; G06T 12/20; G06T 12/30; G06T 2207/10081; G06T 2207/10116; G06T 2207/30141

(57) ABSTRACT

Provided herein are methods, apparatuses, computer program products, and systems for volumetric difference analysis. One method can include obtaining sample computed tomography (CT) data of a first physical object; obtaining reference CT data of one or more second physical objects that correspond to the first physical object; identifying a first boundary of the first physical object in the sample CT data; identifying a second boundary of the one or more second physical objects in the reference CT data; aligning data points of the first boundary with data points of the second boundary to form a transformation matrix; registering the sample CT data with the reference CT data using the transformation matrix to form registered sample and reference CT data; generating difference data from the registered sample and reference CT data; and providing the difference data for processing.

### CROSS-REFERENCE TO RELATED APPLICATIONS

This patent application claims priority to and the benefit of U.S. Provisional Patent Application No. 63/712,207, filed on Oct. 25, 2024, which is incorporated herein by reference in its entirety.

### BACKGROUND

Three-dimensional (3D) X-ray computed tomography (CT) is a powerful inspection technology for both individual parts as well as assembled final products. The 3D scan data from a CT scan combines a series of X-ray projections taken from different projection angles and uses computer processing techniques to create a 3D reconstruction of the scan object. 3D X-ray CT can be used to make quality decisions about a part or to monitor upstream or downstream processes.

### SUMMARY

This specification describes technologies relating to comparing a computed tomography (CT) reconstruction volume of a sample object to a reference volume of a reference object to identify differences between the two objects. In particular, a transformation matrix for aligning boundaries of the two volumes is used to align the two volumes. Once aligned, a difference volume can be obtained by subtracting one volume from another. The difference volume can be rendered and processed using automatic algorithms to locate foreign debris, missing or displaced parts, or other differences between the sample object and the reference object.

Inspection systems may need to detect differences between two seemingly identical instances of the same part or assembly, e.g., comparing a sample part to a reference part. While CT scans can provide information for internal structures of a part or an assembly, it can be difficult to isolate specific differences between two CT scans. Some existing techniques can obtain surface meshes of two objects, e.g., by using 3D surface scanners or extracting surface meshes from CT reconstruction volumes, and compare the surface meshes of the two objects. However, these existing techniques can only compare surface features of the two objects and cannot identify differences inside the objects, such as missing parts or other changes inside the objects, especially for objects that have complex internal structures. For example, some existing systems may not be able to identify which of the thousands of surface-mounted components on a printed circuit board assembly (PCBA) have moved, may not be able to identify which channel in a large electrical connector is blocked by a manufacturing defect, or may not be able to identify which of the eighty specified holes in a part was not drilled correctly.

Some existing techniques for CT volumetric difference analysis may require decomposing the sample volume or the reference volume into subregions, and performing alignment in each of the subregions. These existing techniques may require a large population of nominal scans in order to calculate the reference volume, or may require using computer-aided design (CAD) data as reference data. These existing techniques may use singular value decomposition (SVD) to generate a set of eigenvector modes to represent the volumes.

Particular embodiments of the subject matter described in this specification can be implemented to realize one or more of the following advantages. Rather than performing registration in the voxel domain using voxels that might be different between the CT volumes, the systems and techniques described in this specification can obtain a transformation matrix for alignment in the boundary domain (e.g., in either surface mesh or point cloud domain) that has features that are more consistent, and can register the sample and reference volumes using the transformation matrix obtained in the boundary domain. For the systems that already routinely perform registration between surface meshes or point clouds of CT scan data, the systems and techniques can reuse the transformation matrix for the registration between surface meshes or point clouds and the registration between the two volumes adds very little additional computational cost.

Rather than decomposing a sample volume or a reference volume into subregions and performing alignment in the subregions (e.g., to CAD data), the systems and techniques can achieve registration between the sample volume and the reference volume using a transformation matrix for the registration between surface meshes or point clouds of the two volumes. Rather than requiring a large population of nominal scans or requiring using computer-aided design (CAD) data in order to calculate the reference volume, the systems and techniques can use a reconstruction volume from a single scan as the reference volume, or can generate the reference volume from multiple scans captured in the same or multiple orientations, such as using median fusion or mean fusion. Rather than using SVD to generate a set of eigenvector modes to represent the volumes and performing the subtraction in a derived eigen space, the systems and techniques can perform the subtraction operation in voxel space, thus saving computation time and resources.

In some implementations, CT reconstruction volumes can have very high resolution, and the systems and techniques can still efficiently perform volumetric difference analysis on high resolution CT volumes by obtaining a transformation matrix for down-sampled surface meshes or point clouds of the two volumes, thus saving computation time and resources. In some implementations, all or part of the volumetric difference analysis can be performed at a remote server away from a local computer located at a (manufacturing) inspection site, thus reducing the amount of computation resources required at the local computer. In some implementations, the systems and techniques can reduce the amount of data transferred over the network that connects the local computer and the remote cloud server. For example, instead of transferring high resolution CT volumes from the local computer to the remote server, the systems and techniques only need to transfer the (down-sampled) surface meshes or point clouds to the remote server to perform the registration and to obtain the transformation matrix. After receiving the transformation matrix for the registration of the surface meshes or point clouds from the remote server, the systems and techniques can perform the registration between the sample volume and the reference volume using the transformation matrix at the local computer. The systems and techniques can be used for non-conforming part inspection, tracking an object's change over time, anomaly detection, and failure analysis in many industries, such as medical device manufacturing, automotive manufacturing, and electronics manufacturing. For example, the systems and techniques can detect stray screws in an electronic assembly that may cause electrical shorts and/or product failure. Similarly, the systems and methods can detect missing fasteners or other components in an assembly.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example system that performs volumetric difference analysis.

FIG. 2 shows an example of voxel values in a difference volume.

FIG. 3 is a flowchart showing an example of a process to perform volumetric difference analysis.

FIG. 4A shows an example of a sample volume of a wireless computer mouse containing an electronic circuit board with defects.

FIG. 4B shows an example of a reference volume of a wireless computer mouse without defects.

FIG. 4C shows an example of a difference volume of a wireless computer mouse.

Like reference numbers and designations in the various drawings indicate like elements.

### DETAILED DESCRIPTION

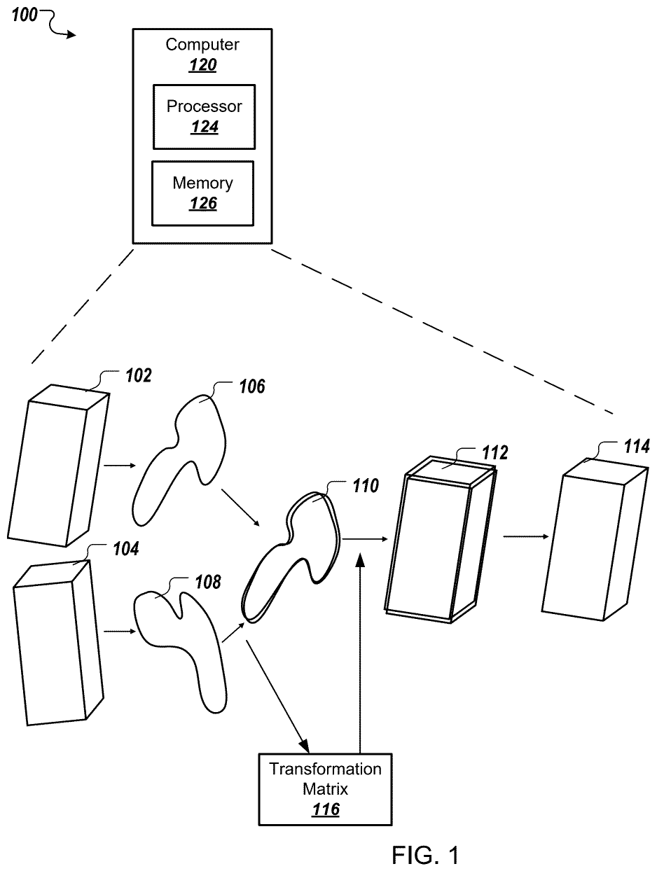

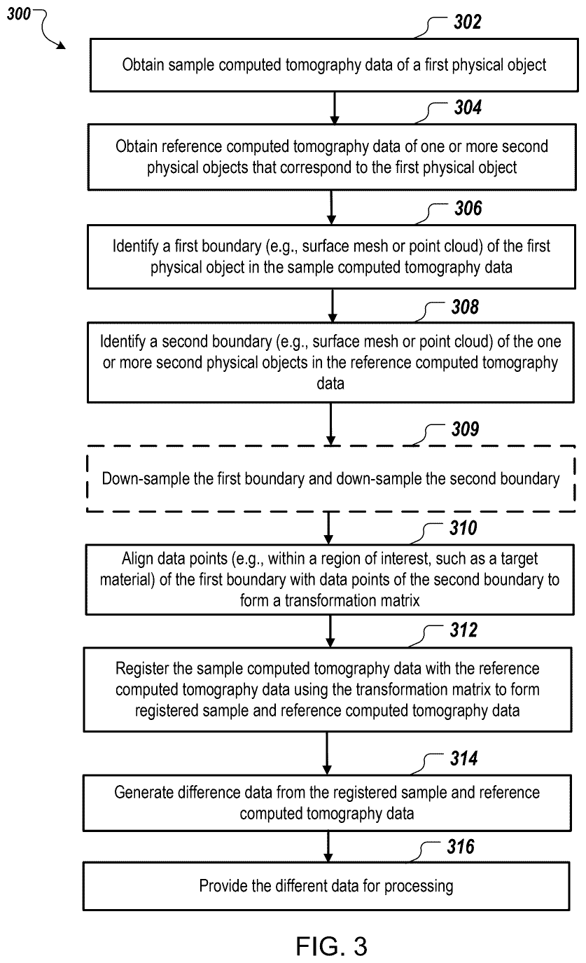

FIG. 1 shows an example system 100 that performs volumetric difference analysis. The system 100 compares a computed tomography (CT) reconstruction volume of a sample object to a reference volume to identify differences between the two volumes. FIG. 3 is a flowchart showing an example of a process 300 to perform volumetric difference analysis. For example, the system 100 in FIG. 1 can perform the process 300.

The system 100 obtains (302) sample CT data of a first physical object. The system 100 obtains (304) reference CT data of one or more second physical objects that correspond to the first physical object. For example, the system 100 can obtain sample CT data 104 of a manufactured part, and the system 100 can obtain reference CT data 102 of a reference part, e.g., a part that does not have defects. The reference CT data 102 can either be a CT reconstruction volume generated from a single scan or can be a volume formed by the fusion of multiple reconstruction volumes. For example, the reference CT data 102 can be generated by averaging of two or more reconstruction volumes or taking a median of three or more reconstruction volumes of two or more second physical objects. In some implementations, the system 100 can perform the volumetric difference analysis to track the changes of an object over time, and the first physical object and the second physical object can be the same object at two different time points. In some implementations, the system can generate the reference volume 102 from CAD data. For example, the system can simulate the X-ray CT process and can reconstruct the simulated radiograph data of the simulated X-ray CT process into the reference volume 102.

The system 100 can obtain a boundary of the CT data. The system 100 identifies (306) a first boundary 108 of the first physical object in the sample CT data 104. The system 100 identifies (308) a second boundary 106 of the one or more second physical objects in the reference CT data 102.

In some implementations, the boundary of the CT data can be a surface mesh extracted from the CT data. For example, the system can identify a surface mesh as the first boundary 108 of the sample CT data 104, and a surface mesh as the second boundary 106 of the reference CT data 102. The system can use marching cubes, flying edges, or any other suitable algorithm, to extract a surface mesh from CT data.

In some implementations the boundary of the CT data can be point cloud data extracted from the CT data. For example, the first and second boundaries 108 and 106 can be point cloud data. In some implementations, the system can use marching cubes, flying edges, or any other suitable algorithm, to extract a surface mesh, and the system can select points on the surface of the surface mesh. For example, the point cloud data can include vertices of the surface mesh selected randomly, uniformly, or using any other suitable sampling methods. In some implementations, the system can skip the meshing process and can determine the point cloud data (e.g., by sampling along an isovalue contour) in the voxel space of the CT data. For example, the system can find voxels within a small range of a surface using a threshold value, and can use the voxels or a subset of the voxels as point cloud data. In some implementations, the system can select the point cloud data using a user input that identifies features of interest in the physical object.

The system 100 aligns (310) data points of the first boundary with data points of the second boundary to form a transformation matrix. For example, the system can align the data points of the first boundary 108 with data points of the second boundary 106 to form a transformation matrix 116. The transformation matrix 116 is a coordinate transform matrix that aligns the data points of the first boundary with the data points of the second boundary by scale, pitch, yaw and/or roll rotations in 3D space.

As discussed above, the data points can be surface meshes or point cloud data. In some implementations, the system 100 can perform the alignment of the boundaries on surface meshes. The data points of the first boundary can include a surface mesh of the first physical object in the sample computed tomography data, and the data points of the second boundary can include a surface mesh of the one or more second physical objects in the reference computed tomography data. The system can align the surface mesh of the first physical object with the surface mesh of the second object to form a transformation matrix.

In some implementations, the system 100 can perform the alignment of the boundaries on point clouds. The data points of the first boundary can include point cloud data of the first physical object in the sample computed tomography data, and the data points of the second boundary can include point cloud data of the one or more second physical objects in the reference computed tomography data. The system can align the point cloud data of the first physical object with the point cloud data of the second object to form a transformation matrix.

The system 100 can perform the alignment of the data points by performing a 3D registration algorithm on the data points, e.g., the surface meshes or the point clouds. For example, the 3D registration algorithm can be iterative closest point (ICP), Global ICP, Random sample consensus (RANSAC), Fast Global Registration (FGR), or any other point-set registration algorithms for registration of rigid objects.

In some implementations, the system 100 can perform the alignment of the boundaries on features targeting specific groups of point clouds or surface meshes. The data points of the first boundary can be within one or more regions of interest of the first physical object, and the data points of the second boundary can be within one or more regions of interest of the one or more second physical objects. The system can align the data points (e.g., surface meshes or point clouds) of the first boundary within the region of interest with the data points (e.g., surface meshes or point clouds) of the second boundary within the region of interest to form a transformation matrix. For example, the system can receive an input (e.g., from a user) that identifies (e.g., user selected) surfaces or features of interest on the two volumes. The system can align the surfaces or features of interest using one or more of the data points alignment methods described herein.

As another example, the first physical object can include two or more materials and the second physical object can include the two or more materials. The system can obtain an input (e.g., from a user) that identifies (e.g., user selected) a target material on the two volumes. The system can identify the data points of the first boundary that are within a region of interest corresponding to the target material of the first physical object. The system can identify the data points of the second boundary that are within a region of interest corresponding to the target material of the second physical object. For example, the system can identify the data points of the first boundary or the second boundary using one or more threshold values or using a segmentation algorithm. Example segmentation algorithms include random forest segmentation, k-means clustering, gradient-based methods, and neural networks, such as U-Nets. In some implementations, the data points can correspond to a target structure in the physical object that can be more easily registered than other structures in the physical object.

The system can align the data points of the first boundary corresponding to the target material and the data points of the second boundary corresponding to the target material using one or more of the data points alignment methods described herein. For example, the system can align the data points of the first boundary corresponding to the target material and the data points of the second boundary corresponding to the target material to form a transformation matrix, e.g., by performing a 3D registration algorithm on the data points.

In some implementations, a region of interest can be defined by a material type. The system can align the region of interest for the material type in the sample volume with the same region of interest for the same material type in the reference volume, without using other regions in the two volumes. For example, the physical object can be a device that includes a battery. The battery's position in the device may have shifted before and after using the device. The system can obtain reference CT data for the device before using the device. The system can obtain sample CT data for the device after using the device. The system can obtain, in the sample CT data, data points of the first boundary corresponding to a target material for the battery using a segmentation algorithm. The system can obtain, in the reference CT data, data points of the second boundary corresponding to the target material for the battery using the segmentation algorithm. The system can register the sample CT data and the reference CT data using data points for the first and the second boundaries corresponding to the battery, such that the system can compare the battery before and after using the device. As another example, the physical object can be a shoe. The shoe can include features that are associated with a target material. The system can select the features using a segmentation algorithm for the target material. The system can use the features as landmarks for the registration of sample CT data and reference CT data for the shoe.

In some implementations, the system 100 can monitor changes of an object over time by comparing two CT scans (e.g., the sample CT data 104 and the reference CT data 102) of the same object at two different time points. The system 100 can perform the alignment of the boundaries of the two CT scans using data points for features at one or more regions that do not change over time. For example, the system can perform volumetric difference analysis on a running shoe before and after use, the system can exclude the surfaces that have been worn down from the data points that are used to perform the alignment. As another example, the system can compare an electronic device that contains a battery before and after the electronic device failed and the battery has expanded in size, and the system can perform accurate alignment of two CT reconstruction volumes before and after the failure incident by excluding regions, such as the battery, that are known to be different between the two reconstruction volumes. The system can select features (such as screws, pins, or housing features) that likely have not changed between the two times at which the electronic device was scanned.

In some implementations, the system can perform a registration for each of multiple corresponding components in the sample and the reference CT data to form multiple candidate transformation matrices. The system can then generate the transformation matrix 116 by combining (e.g., averaging or voting between candidate matrices) the multiple candidate transformation matrices. For example, the system can use intensity differences between different materials to perform multiple registrations on scans of multi-material objects to get an improved volumetric registration result. For example, the system 100 can align a plastic part, one or more screws, one or more printed circuit board (PCB) components separately, and the system 100 can combine their transformations to generate the transformation matrix 116.

In some implementations, before aligning the data points of the first boundary with the data points of the second boundary to form the transformation matrix, the system 100 can down-sample (309) the first boundary and the second boundary, and then the system can perform the alignment on the down-sampled boundaries. The system 100 can apply any suitable down-sampling techniques, such as Poisson disk sampling, random sampling, and uniform sampling. In some implementations, the system can vary the marching cube step parameter that is used for generating the surface mesh from the CT data to generate a down-sampled surface mesh from the CT data. Because the down-sampled boundaries can retain large features of the CT data, alignments performed using the down-sampled boundaries can increase the speed of the alignment computation by reducing the amount of computation required, without reduction in alignment quality.

In some implementations, the data points of the first boundary can include a down-sampled surface mesh of the first physical object in the sample computed tomography data, and the data points of the second boundary can include a down-sampled surface mesh of the one or more second physical objects in the reference computed tomography data. The system 100 can align the down-sampled surface mesh of the first physical object with the down-sampled surface mesh of the second object to form a transformation matrix.

In some implementations, the data points of the first boundary can include down-sampled point cloud data of the first physical object in the sample computed tomography data, and the data points of the second boundary can include down-sampled point cloud data of the one or more second physical objects in the reference computed tomography data. The system 100 can align the down-sampled point cloud data of the first physical object with the down-sampled point cloud data of the second object to form a transformation matrix.

The system 100 registers (312) the sample CT data with the reference CT data using the transformation matrix to form registered sample and reference CT data. For example, the system 100 can apply the transformation matrix 116 to the sample CT data 104 that generates the first boundary 108. Therefore, the system can align the sample CT data 104 to the reference CT data 102 and can obtain the registered sample and reference CT data 112.

In some implementations, the system 100 can register the sample CT data and the reference CT data using 2D or 3D registration techniques, such as matching feature descriptors extracted from 2D images or 3D volumes. For example, 2D registration (image matching) techniques can include Scale-Invariant Feature Transform (SIFT), Speeded Up Robust Feature (SURF), Robust Independent Elementary Features (BRIEF), Features from Accelerated Segment Test (FAST), and Oriented FAST and Rotated BRIEF (ORBS). These 2D registration techniques can detect key points or feature descriptors and 2D registration can be performed by matching the key points or the feature descriptors. These 2D registration techniques can be extended to 3D registration to register the sample CT data and the reference CT data. For example, 3D SIFT algorithm can detect and describe key points in a 3D volume, such as the reference CT data and the sample CT data. In some implementations, the system 100 can register the sample CT data and the reference CT data using cross-correlation analysis, or other brute force methods. In some implementations, the system 100 can register the sample CT data and the reference CT data using any suitable 3D registration methods, such as other image registration methods extended to 3D. In some implementations, the system 100 can register the sample CT data and the reference CT data based on a user input. For example, a user can manually register the sample CT data and the reference CT data.

The system 100 generates (314) difference data from the registered sample and reference CT data, and the difference data characterizes disparity between the first physical object and the one or more second physical objects. For example, the system 100 can generate the difference data 114 by subtracting the registered sample from the reference CT data 112, or vice versa. The disparity between the first physical object and the one or more second physical objects can include foreign debris, missing or displaced parts, or other differences. Thus, the sample CT data can be compared to the reference CT data using the difference data because the difference data removes the similarities between the sample CT data and the reference CT data and shows the differences between the sample CT data and the reference CT data.

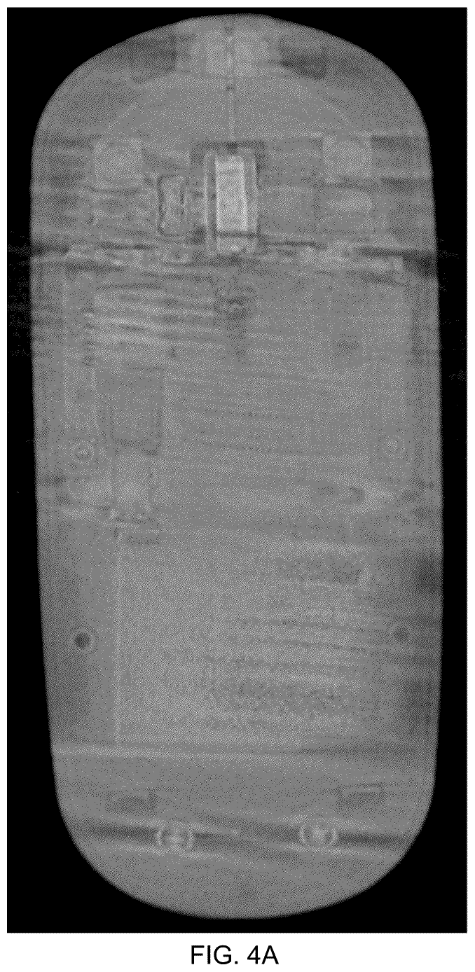

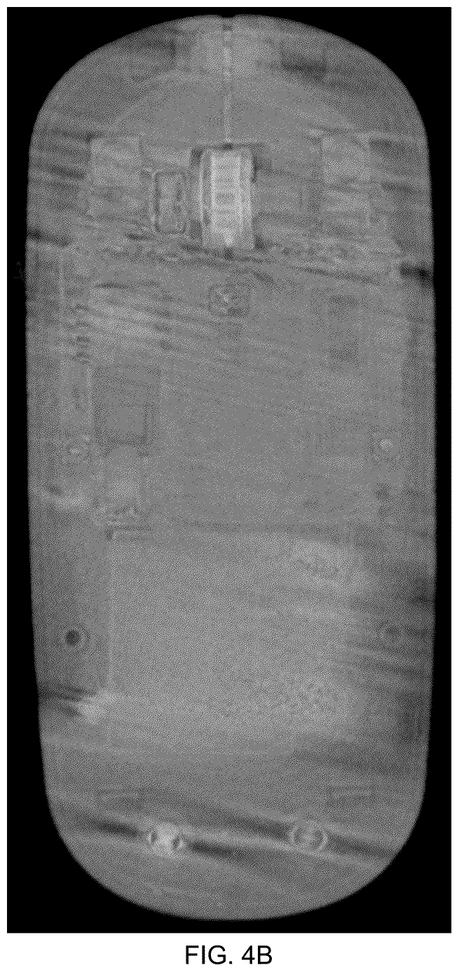

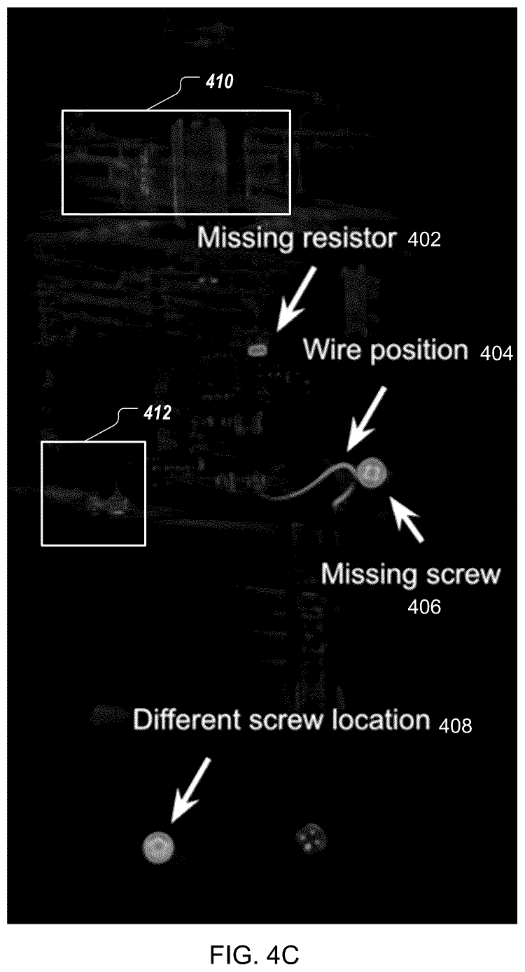

FIG. 4A shows an example of a sample volume of a wireless computer mouse containing an electronic circuit board with defects. FIG. 4B shows an example of a reference volume of a wireless computer mouse without defects. FIG. 4C shows an example of a difference volume of a wireless computer mouse, generated by subtracting the sample volume shown in FIG. 4A from the reference volume shown in FIG. 4B. The difference volume in FIG. 4C shows differences between the sample volume and the reference volume. For example, the difference volume in FIG. 4C shows a missing resistor 402, a different position for a wire 404, a missing screw 406, and a displacement of a screw 408.

In some implementations, the voxel values in the difference data can be signed or unsigned integers, signed or unsigned floating point values, or any other suitable data types, represented using a predetermined number of bits, e.g., 8 bits, 16 bits, 32 bits, or 64 bits. In some implementations, a positive value can indicate that the first physical object at that voxel location gained density, which corresponds to gained material or foreign debris. A zero value indicates that the first physical object at that voxel location did not change density. A negative value in space can indicate that the first physical object at that voxel location lost density, which correlates to missing material or a missing component. In some implementations, a positive value can indicate that the first physical object at that voxel location lost density, and a negative value can indicate that the first physical object at that voxel location gained density. Unsigned voxel values (e.g., unsigned integers) can also be used for the difference data, but using signed values (with two's complement binary representation) for the difference data can result in processing speed benefits.

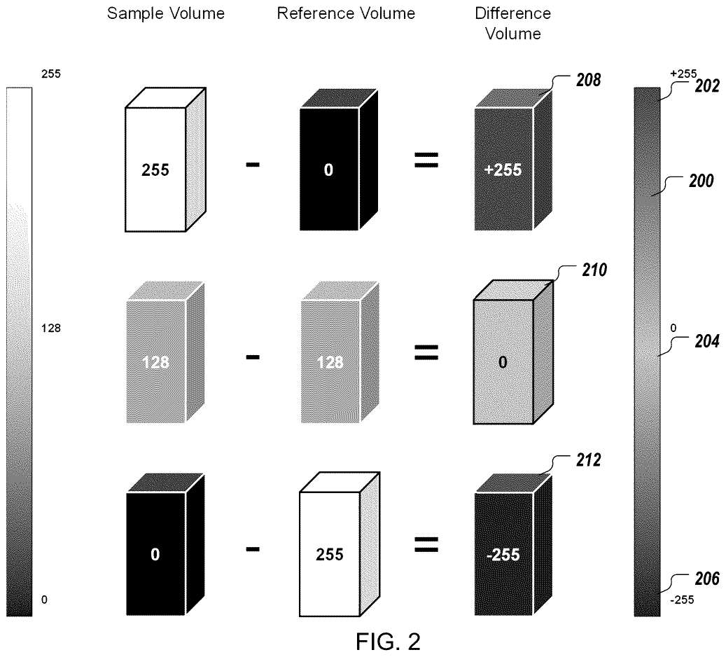

FIG. 2 shows an example of voxel values in a difference volume. The voxel values in the sample volume and the reference volume are unsigned integers encoded using 8 bits and can range from 0 to 255. The voxel values in the difference volume are signed integers encoded using 9 bits and can range from −255 to +255. The system can generate the difference volume by subtracting the registered reference volume from the registered sample volume. If the sample volume has higher density than the reference volume at a voxel location, the difference volume at the voxel location is positive. For example, if the sample volume is 255 and the reference volume is 0 at a voxel location, the difference volume at the location of voxel 208 is +255. If the sample volume has the same (or approximately the same) density as the reference volume at a voxel location, the difference volume at the voxel location is zero (or close to zero). For example, if the sample volume is 128 and the reference volume is also 128 at a voxel location, the difference volume at the location of voxel 210 is 0. If the sample volume has lower density than the reference volume at a voxel location, the difference volume at the voxel location is negative. For example, if the sample volume is 0 and the reference volume is 255 at a voxel location, the difference volume at the location of voxel 212 is −255.

The system 100 provides (316) the difference data for processing. In some implementations, the system can render the difference data on a display device. In some implementations, providing (316) the difference data for processing can include displaying the difference data on a user interface.

In some implementations, the system 100 can encode the voxel values of the difference data using different colors or different grayscale levels and can display the difference data using the different colors or the different grayscale levels. Referring to FIG. 2, the system can represent the voxel values using a color bar 200 that gradually changes color from blue (206) to green (204) and to red (202), corresponding to voxel values that range from −255 to 0, and to 255. A missing part in the first physical object can correspond to voxel values below 0 (e.g., the voxel 212) and is displayed with blue or blue-greenish colors. An added part in the first physical object can correspond to voxel values above 0 (e.g., the voxel 208) and is displayed with red or red-greenish colors. A part in the first physical object that matches well with the reference volume is displayed in green color, such as the color green 204 for the voxel 210.

In some implementations, the system 100 can use one or more automatic algorithms to process the difference data to determine disparity between the first physical object and the one or more second physical objects. In some implementations, providing (316) the difference data for processing can include processing the difference data using an automatic algorithm to determine a property of the disparity between the first physical object and the one or more second physical objects based on the segmentation data. In some implementations, the automatic algorithm can include a segmentation algorithm, a detection algorithm, a classification algorithm, or a combination of these. In some implementations, the automatic algorithm can include an algorithm that measures one or more similarity metrics, such as one or more 2D image similarity metrics that are extended into the 3D domain. For example, the automatic algorithm can include one or more of the following: thresholding on maximum difference, thresholding on cumulative difference, and thresholding on clustered differences, and examples of the one or more similarity metrics include Structured Image Similarity Metric, Feature-Based Similarity Metrics, Universal Image Quality Index, and Information theoretic-based Statistic Similarity Measure.

In some implementations, the property of the disparity between the first physical object and the one or more second physical objects can include a volume for the disparity. The disparity can include one or more regions that are different between the first physical object and the one or more second physical objects. In some implementations, the system can use a segmentation algorithm to generate a segmentation mask for each of the one or regions of the disparity and can predict the volume for each region by measuring the volume of the segmentation mask. In some implementations, the system can measure a volume for each of the one or more regions that are different between the first physical object and the one or more second physical objects. The volume for each region of disparity can characterize the magnitude of displacement and/or the size of a foreign or missing material.

For example, in FIG. 4C, the disparity can include four regions corresponding to the missing resistor 402, the displacement of the wire 404, the missing screw 406, and the displacement of the screw 408. The system can generate a volume for each region. For example, the system can generate a volume for the missing screw 406 and the volume for the missing screw 406 can characterize the size of the missing screw. The system can generate a volume for the displacement of the wire 404 and the volume can characterize the magnitude of displacement.

In some implementations, the property of the disparity between the first physical object and the one or more second physical objects can include a predicted material for the disparity. For example, based on the intensity of the disparity, the system can generate a prediction for the material, such as ceramic, polymer, or metal. For example, in FIG. 4C, the system can generate a predicted material for the missing screw 406.

In some implementations, the property of the disparity between the first physical object and the one or more second physical objects can include a predicted object type for the disparity. For example, the system can process each of the one or more regions of the disparity using an object detector or an object classifier to generate the predicted object type (e.g., a screw, a retention clip, or a wire) for the disparity. The system can predict the likely object type of a foreign debris or a negative deviation (e.g., a missing part) based on the density, the shape, or other properties of each of the one or more regions of the disparity in the difference volume. For example, in FIG. 4C, the system can process the voxels in a 3D region of the missing screw 406 using an object classifier to generate a predicted object type for the region, and the predicted object type can indicate that the region likely corresponds to a screw.

In some implementations, the system 100 can set a decision threshold for the automatic algorithm based on an expected variation. The system can compute differences between CT data within a region of interest for three or more third physical objects that correspond to the first physical object. In some implementations, the CT data for the three or more third physical objects can include radiographs or reconstruction volumes for the three or more third physical objects. The system 100 can calculate an expected variation within the region of interest as a variation of the differences between the computed tomography data within the region of interest for the three or more third physical objects. In some implementations, the expected variation within the region of interest can include an expected variation in magnitude, direction, and/or location for a part within the region of interest. The system 100 can set a decision threshold for the automatic algorithm based on the expected variation. The system 100 can process the difference data within the region of interest using the automatic algorithm and using the decision threshold to determine the property of the disparity within the region of interest.

For example, the system 100 can compare multiple scans (e.g., two-dimensional radiographs or three-dimensional reconstruction volumes) to determine expected variation (e.g., magnitude, direction, or location) in a given application. The system 100 can use the expected variation to set thresholds for automated decision-making applications for volumetric difference analysis.

For example, the system can use the volumetric different analysis techniques described herein to verify an assembly on a printed circuit board assembly (PCBA). An assembly on a PCBA can have some expected level of variation in the placement and/or density of the individual components. The system can measure the expected and/or acceptable variation (e.g., standard deviation, variance, or a range) in a region. The system can more accurately set the threshold value for the automatic algorithm for volumetric difference analysis. For example, if voxel values in a region of the difference data are above the expected and/or acceptable variation, the system can determine that there is a high likelihood that there is a defect (e.g., a missing, extra, or incorrect component) in the region. For example, in FIG. 4C, the voxel values in the regions 410 and 412 are below the expected and/or acceptable variation, the system 100 can determine that there is a low likelihood that there is a defect in these regions.

In some implementations, the system 100 or another machine learning training system can train the automatic algorithm on training data that is generated using differences between computed tomography data within a region of interest for three or more third physical objects that correspond to the first physical object. The training data can indicate expected variations (e.g., sign, magnitude, location, volume, shape) between objects. Thus, the system can use the statistical variation from a sample population to classify the difference volume generated from a new individual sample.

For example, the system can train a classifier to classify a disparity region in the difference volume as “expected variation” or “anomalous variation.” As another example, in electronics, surface mounted components can vary in placement by some amount naturally. By characterizing this variation in a population of scans of different instances of the part or assembly, the system can measure the natural distribution. The system can generate data characterizing the volume, location, sign, and shape of deviation volumes. The data can indicate expected variation and the system can use the data to specify a threshold on these metrics, or to train an automatic algorithm (e.g., a classifier or a detector) on these metrics to identify anomalous deviations.

The system 100 can perform the volumetric difference analysis techniques in various applications, such as non-conforming part inspection, tracking an object's change over time, anomaly detection, and failure analysis, and in many industries, such as medical device manufacturing, automotive manufacturing, and electronics manufacturing. In some implementations, the first physical object can be an electric circuit board, and the disparity between the first physical object and the one or more second physical objects can correspond to a manufacturing defect of the electric circuit board. Electronic assemblies can have thousands of surface-mounted components on a PCBA, and the system can accurately identify defects in electronic assemblies. For example, the system can identify one or more displaced components on a PCBA, can identify which channel in a large electrical connector is blocked by a manufacturing defect, or can identify, from tens or hundreds of holes, one or more holes in a part that were not drilled correctly.

The system 100 can perform an inspection of a part manufactured using additive manufacturing, subtractive manufacturing, molding manufacturing, or other manufacturing techniques. In some implementations, the first physical object can be manufactured using a molding manufacturing process, and the disparity between the first physical object and the one or more second physical objects can correspond to an added material or a missing material resulting from the molding manufacturing process. For example, the system 100 can detect defects in an injection molded part, such as surplus materials (e.g., flash), or missing materials (e.g., sink, porosity, or a short shot).

In some implementations, the first physical object can be manufactured using a subtractive manufacturing process, and the disparity between the first physical object and the one or more second physical objects can correspond to a missing material resulting from the subtractive manufacturing process. For example, the system 100 can detect missing negative features (e.g., holes) in machined and cast components.

In some implementations, the first physical object can be manufactured using an additive manufacturing process, and the disparity between the first physical object and the one or more second physical objects can correspond to distortion or added material resulting from the additive manufacturing process. For example, the system 100 can detect surplus materials in a 3D printed object.

In some implementations, the first physical object can be an assembled object, and the disparity between the first physical object and the one or more second physical objects can correspond to an object added or missed during the assembly of the first physical object. For example, the system 100 can detect foreign objects and debris (FOD) (e.g., screws) that could potentially cause damage to an assembly.

The system 100 includes a computer 120. In some implementations, the computer 120 can be one or more computers that are integrated with a CT scanner that generates one or both of the sample CT data 104 and the reference CT data 102, and/or located remotely from the CT scanner (e.g., at a remote server and communicatively coupled with the CT scanner, e.g., over the Internet). The computer 120 can include a processor 124 (i.e., one or more processing devices). The processor 124 can be embodied by any computational or data processing device, such as a central processing unit (CPU), application specific integrated circuit (ASIC), or comparable device. The processor 124 can be implemented as a single controller, or a plurality of controllers or processors.

The computer 120 can include a memory 126 (i.e., one or more memory devices). The memory 126 can be fixed or removable. The memory 126 can encode computer program instructions or computer code contained therein. Memory 126 can be any suitable storage device, such as a non-transitory computer-readable medium. The term “non-transitory,” as used herein, can correspond to a limitation of the medium itself (i.e., tangible, not a signal) as opposed to a limitation on data storage persistency (e.g., random access memory (RAM) vs. read-only memory (ROM)). A hard disk drive (HDD), random access memory (RAM), flash memory, or other suitable memory can be used. The one or more memories can be combined on a same integrated circuit as one or more processors, or can be separate from the one or more processors. Furthermore, the computer program instructions stored in the memory, and which can be run by the processor(s), can be any suitable form of computer program code, for example, a compiled or interpreted computer program written in any suitable programming language. In some implementations, the computer 120 can store computer data structure representing the sample CT data 104, the reference CT data 102, the first boundary 108, the second boundary 106, the aligned boundaries 110, the registered sample and reference CT data 112, the difference data 114, or a combination of these, in the memory 126.

The processor 124, the memory 126, and any subset thereof, can be configured to perform one or more processes including aligning data points of the boundaries of the sample and reference CT data, registering the sample and the reference CT data, generating the difference data, displaying the difference data, and processing the difference data using an automatic algorithm to characterize disparity between the sample and the reference CT data. The memory and the computer program instructions can be configured, with the processor for the particular device, to cause a hardware apparatus to perform one or more of the processes described in this application. Therefore, in some implementations, a non-transitory computer-readable medium is encoded with computer instructions that, when executed in hardware, perform a process such as one of the processes described herein. In some cases, one or more of the processes described herein are implemented entirely in hardware.

As noted above, in some implementations, these processes can be performed by the computer 120 that is separate from the CT scanner. In some implementations, these processes can be performed by a CT scanner, and so no separate computer is needed. In such implementations, the computer 120 and the CT scanner can be integrated into a single device, rather than being in separate devices. In some implementations, the CT scanner can be an inexpensive scanning device with minimal processing capabilities, and a separate computer 120 is communicatively coupled with the CT scanner and is configured to perform one or more of the processes described herein.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented using one or more modules of computer program instructions encoded on a non-transitory computer-readable medium for execution by, or to control the operation of, data processing apparatus. The computer-readable medium can be a manufactured product, such as a hard drive in a computer system or an optical disc sold through retail channels, or an embedded system. The computer-readable medium can be acquired separately and later encoded with the one or more modules of computer program instructions, such as by delivery of the one or more modules of computer program instructions over a wired or wireless network. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, a runtime environment, or a combination of one or more of them. In addition, the apparatus can employ various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media, and memory devices, including by way of example semiconductor memory devices, e.g., EPROM (Erasable Programmable Read-Only Memory), EEPROM (Electrically Erasable Programmable Read-Only Memory), and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display) display device, an OLED (organic light emitting diode) display device, or another monitor, for displaying information to the user, and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The computing system can include clients and servers. A client and server are generally remote from each other and typically interact through a communication network. The relationship of client and server arises by virtue of computer programs running on the respective computers and having a client-server relationship to each other. Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many implementation details, these should not be construed as limitations on the scope of what is being or may be claimed, but rather as descriptions of features specific to particular embodiments of the disclosed subject matter.

Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desired results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims.

What is claimed is:

1. A method comprising:
obtaining sample computed tomography data of a first physical object;
obtaining reference computed tomography data of one or more second physical objects that correspond to the first physical object;
identifying a first boundary of the first physical object in the sample computed tomography data;
identifying a second boundary of the one or more second physical objects in the reference computed tomography data;
aligning data points of the first boundary with data points of the second boundary to form a transformation matrix;
registering the sample computed tomography data with the reference computed tomography data using the transformation matrix to form registered sample and reference computed tomography data;
generating difference data from the registered sample and reference computed tomography data, wherein the difference data characterizes disparity between the first physical object and the one or more second physical objects; and
providing the difference data for processing.

2. The method of claim 1, wherein the data points of the first boundary comprise a surface mesh of the first physical object in the sample computed tomography data, and the data points of the second boundary comprise a surface mesh of the one or more second physical objects in the reference computed tomography data.

3. The method of claim 1, wherein the data points of the first boundary comprise point cloud data of the first physical object in the sample computed tomography data, and the data points of the second boundary comprise point cloud data of the one or more second physical objects in the reference computed tomography data.

4. The method of claim 1, wherein the data points of the first boundary comprise a down-sampled surface mesh of the first physical object in the sample computed tomography data, and the data points of the second boundary comprise a down-sampled surface mesh of the one or more second physical objects in the reference computed tomography data.

5. The method of claim 1, wherein the data points of the first boundary comprise down-sampled point cloud data of the first physical object in the sample computed tomography data, and the data points of the second boundary comprise down-sampled point cloud data of the one or more second physical objects in the reference computed tomography data.

6. The method of claim 1, wherein the data points of the first boundary are within a region of interest of the first physical object, and the data points of the second boundary are within a region of interest of the one or more second physical objects.

7. The method of claim 6, wherein:
the first physical object comprises two or more materials, the data points of the first boundary are within the region of interest corresponding to a target material of the first physical object, and
the second physical object comprises the two or more materials, the data points of the second boundary are within the region of interest corresponding to the target material of the second physical object.

8. The method of claim 1, wherein providing the difference data for processing comprises displaying the difference data on a user interface.

9. The method of claim 1, wherein providing the difference data for processing comprises:
processing the difference data using an automatic algorithm to determine a property of the disparity between the first physical object and the one or more second physical objects.

10. The method of claim 9, wherein the property of the disparity between the first physical object and the one or more second physical objects comprises a volume for the disparity.

11. The method of claim 9, wherein the property of the disparity between the first physical object and the one or more second physical objects comprises a predicted material for the disparity.

12. The method of claim 9, wherein the property of the disparity between the first physical object and the one or more second physical objects comprises a predicted object type for the disparity.

13. The method of claim 9, wherein processing the difference data using the automatic algorithm to determine the property of the disparity comprises:
computing differences between computed tomography data within a region of interest for three or more third physical objects that correspond to the first physical object;
calculating an expected variation within the region of interest as a variation of the differences between the computed tomography data within the region of interest for the three or more third physical objects;
setting a decision threshold for the automatic algorithm based on the expected variation; and
processing the difference data within the region of interest using the automatic algorithm and the decision threshold to determine the property of the disparity within the region of interest.

14. The method of claim 13, wherein the expected variation within the region of interest comprises an expected variation in magnitude, direction, and/or location for a part within the region of interest.

15. The method of claim 13, wherein the computed tomography data for the three or more third physical objects comprises radiographs or reconstruction volumes for the three or more third physical objects.

16. The method of claim 9, wherein the automatic algorithm comprises a segmentation algorithm, a detection algorithm, a classification algorithm, or a combination of these.

17. The method of claim 1, wherein the first physical object is an electric circuit board, and the disparity between the first physical object and the one or more second physical objects corresponds to a manufacturing defect of the electric circuit board.

18. The method of claim 1, wherein the first physical object is manufactured using a molding manufacturing process, and the disparity between the first physical object and the one or more second physical objects corresponds to an added material or a missing material resulting from the molding manufacturing process.

19. The method of claim 1, wherein the first physical object is manufactured using a subtractive manufacturing process, and the disparity between the first physical object and the one or more second physical objects corresponds to a missing material resulting from the subtractive manufacturing process.

20. The method of claim 1, wherein the first physical object is manufactured using an additive manufacturing process, and the disparity between the first physical object and the one or more second physical objects corresponds to an added material resulting from the additive manufacturing process.

21. The method of claim 1, wherein the first physical object is an assembled object, and the disparity between the first physical object and the one or more second physical objects corresponds to an object added or missed during the assembly of the first physical object.

22. A system comprising:
a data processing apparatus including at least one hardware processor; and
a non-transitory computer-readable medium encoding instructions configured to cause the data processing apparatus to perform operations comprising:
obtaining sample computed tomography data of a first physical object;
obtaining reference computed tomography data of one or more second physical objects that correspond to the first physical object;
identifying a first boundary of the first physical object in the sample computed tomography data;
identifying a second boundary of the one or more second physical objects in the reference computed tomography data;
aligning data points of the first boundary with data points of the second boundary to form a transformation matrix;
registering the sample computed tomography data with the reference computed tomography data using the transformation matrix to form registered sample and reference computed tomography data;
generating difference data from the registered sample and reference computed tomography data, wherein the difference data characterizes disparity between the first physical object and the one or more second physical objects; and
providing the difference data for processing.

23. A non-transitory computer-readable medium encoding instructions operable to cause a data processing apparatus to perform operations comprising:
obtaining sample computed tomography data of a first physical object;
obtaining reference computed tomography data of one or more second physical objects that correspond to the first physical object;
identifying a first boundary of the first physical object in the sample computed tomography data;
identifying a second boundary of the one or more second physical objects in the reference computed tomography data;
aligning data points of the first boundary with data points of the second boundary to form a transformation matrix;
registering the sample computed tomography data with the reference computed tomography data using the transformation matrix to form registered sample and reference computed tomography data;
generating difference data from the registered sample and reference computed tomography data, wherein the difference data characterizes disparity between the first physical object and the one or more second physical objects; and
providing the difference data for processing.
